(19) United States
(12) Patent Application Publication
(10) Pub. No.: US 2018/0284932 A1
(43) Pub. Date: Oct. 4, 2018

(54) TRANSPARENT DISPLAY FOR RESILIENT VEHICLE SURFACES

(71) Applicant: Honda Motor Co., Ltd., Tokyo (JP)

(72) Inventor: Michael NEHMAD, San Francisco, CA (US)

(21) Appl. No.: 15/476,368

(22) Filed: Mar. 31, 2017

(51) Int. Cl. G06F 3/041; G06F 3/044; G02F 1/1333; B60K 35/00

(52) U.S. Cl. CPC G06F 3/0412; G06F 3/044; G02F 1/13338; B60K 2350/921; B60K 2350/1032; B60K 2350/2095; B60K 35/00

(57) ABSTRACT

The systems and methods provided herein are directed to providing an touch interface on a transparent vehicle window by selectively providing current to an electro-reactive dye embedded within the window. Capacitive touch sensors relay user interaction with the display and allow for control of selected vehicle and device functions by means of the window display. The window display adapts to the user's position and the position of the window by altering the display position.

### BACKGROUND

Automotive design can be form and function. This can sometimes place a limit on a technology's usability in the automotive space. The user interface can be one area to enhance the user experience.

### BRIEF DESCRIPTION

According to one exemplary embodiment, user display within a vehicle is provided. The system can include a window, a plurality of circuit components, and a controller. The window can include an electro-reactive dye between two layers of transparent material. The window moves relative to a surrounding surface of the vehicle. Each component selectively applies an electric current to a different one of a plurality of regions of the electro-reactive dye to adjust the transparency of the one region. The controller is in communication with the plurality of circuit components. The controller creates a display image in a first area of the window by controlling each of the plurality of circuit components and selectively applying electric current to a first selected plurality of the regions of the electro-reactive dye. In response to determining that the window has moved relative to the surrounding surface of the vehicle, the controller creates a display image in a second area of the window by controlling each of the plurality of circuit components and selectively applying electric current to a second selected plurality of the regions of the electro-reactive dye.

In some embodiments, the controller can, in response to determining that a position of a passenger has moved relative to the window, controlling the circuit components to create a display image in a third area of the window.

In some embodiments, a plurality of capacitive touch sensors can relay a plurality of distinguishable user inputs from contact with the window. The controller can further relay one of a plurality of different control demands to a vehicle control system based on identifying the relayed user input and the created display image. The relayed command can be, for example, an entertainment system control command, a climate system control command, a navigation system control command, an automobile interior control command, a communication device control command, or an automobile information status request.

In some aspects of disclosed embodiments, the controller can further receive information from the vehicle control system in response to the relayed command and respond by altering the display image. If the relayed command results in moving the window, the display image can be repositioned to compensate for the moved window. If the relayed command results in moving a user's seat within the vehicle, the display image can be repositioned to compensate for the moved seat.

In some embodiments, the transparency of the displayed image can be selected to contrast with a user-selected transparency of the window.

In some embodiments, the window can include one of a liquid crystal film, switchable transparent film, or polymer dispersed liquid crystal film.

In some embodiments, the transparent material can be shatter-resistant glass meeting industry standards for use in a consumer passenger vehicle.

According to one exemplary embodiment, a computer-implemented method is provided. The method can include selectively applying current to fewer than all of a plurality of circuit components contacting regions of electro-reactive dye within a vehicle window in order to create an image in a first area of the window with a contrast in transparency between the selected regions and adjacent regions of the dye; and, in response to determining that the window has moved relative to a surrounding surface of the vehicle, selectively applying the current to a different plurality of the circuit components to create the image in a second area of the window.

In some embodiments, the method can further include, in response to determining that a position of a passenger has moved relative to the window, selectively applying the current to a further different plurality of the circuit components to create the image in a third area of the window.

In some embodiments, the method can further include receiving, from at least one of a plurality of capacitive touch sensors, data representing at least one of a plurality of distinguishable user inputs from contact with the window. The method can additionally include relaying one of a plurality of different control demands to a vehicle control system based on identifying the relayed user input and the created display image. The relayed command can be one of an entertainment system control command, a climate system control command, a navigation system control command, an automobile interior control command, a communication device control command, or an automobile information status request.

In some embodiments, the method can further include altering the display image based on information received from the vehicle control system in response to the relayed command. If the relayed command results in moving the window, the display image can be repositioned to compensate for the moved window. If the relayed command results in moving a user's seat within the vehicle, the display image can be repositioned to compensate for the moved seat.

In some embodiments, the transparency of the displayed image can be selected to contrast with a user-selected transparency of the window.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIGS. 1A and 1B are illustrations of a display on an exemplary transparent vehicle window in accordance with one aspect of the present disclosure;

FIG. 2 is a cross-sectional diagram of the exemplary transparent vehicle window in accordance with one aspect of the present disclosure;

FIG. 3 is a component diagram illustrating an exemplary vehicle electrical system in accordance with one aspect of the present disclosure; and

FIG. 4 is a flow diagram illustrating an exemplary method for providing a user interface in accordance with one aspect of the present disclosure.

### DESCRIPTION OF THE DISCLOSURE

The description set forth below in connection with the appended drawings is intended as a description of exemplary embodiments of the disclosure and is not intended to represent the only forms in which the present disclosure can be constructed and/or utilized. The description sets forth the functions and the sequence of blocks for constructing and operating the disclosure in connection with the illustrated embodiments. It is to be understood, however, that the same or equivalent functions and sequences can be accomplished by different embodiments that are also intended to be encompassed within the spirit and scope of this disclosure.

Generally described, the systems and methods herein are directed to providing a vehicle window with a user interface suitable to control one or more features of the vehicle. A film is applied to conventional window glass, the film having transparency properties that can be varied by running electric current through the film. The circuitry controlling the film can form images on the window using the contrast between more and less transparent regions. Capacitive touch sensors associated with the glass can allow a user to interact with the images as with a touch interface.

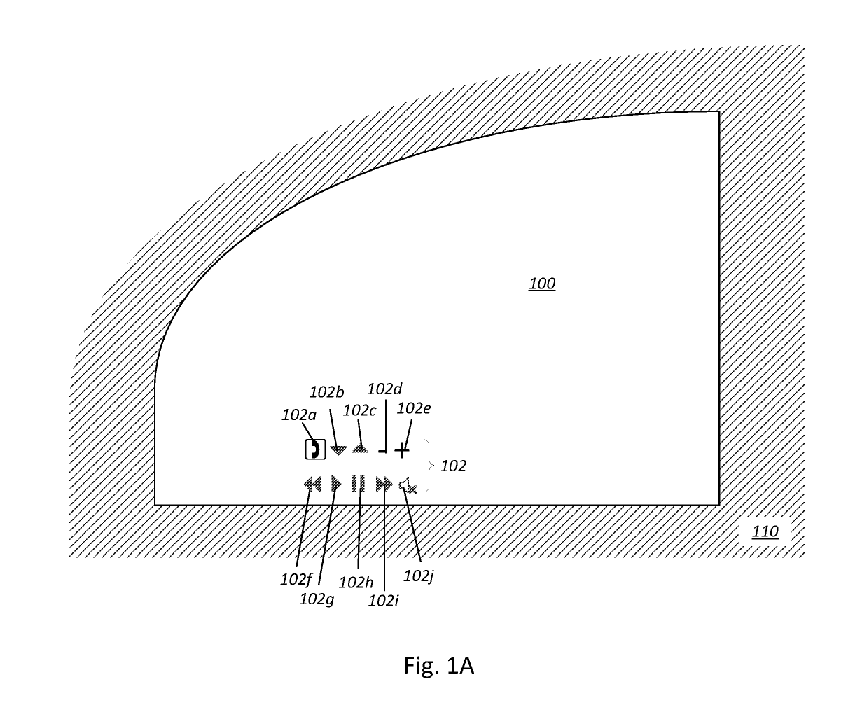

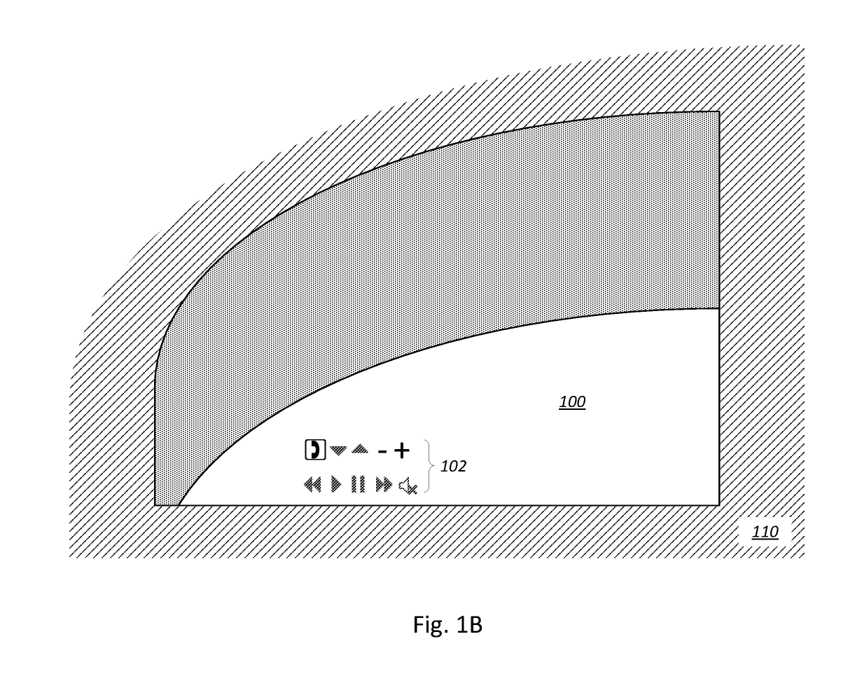

As shown in FIG. 1A, a vehicle window 100 within a vehicle door 110 can include a plurality of display elements 102a-j. Each of the display elements 102 can represent a region of a substrate within the window 100 that is selectively rendered more or less transparent than the region surrounding it by the methods described herein.

FIG. 1B shows the vehicle window 100, now partially retracted into the vehicle door 110 (a second shading pattern is used to represent the open area between the white of the window 100 and the shaded vehicle door 110). The same display elements 102a-j can be shown in the same position relative to a passenger seated adjacent the window. However, with respect to the window 100 surface itself, the display elements can be translated upward to accommodate the downward retraction of the window 100.

The display elements 102 can be control elements for vehicle functions, which in some implementations can be touchable interfaces that a vehicle computer system can react to. Such functions can include adjusting an entertainment device such as an audio or video device, a navigation device such as GPS, or an vehicle interface to a phone or other communication device. Other control elements can include adjusting a seat, moving a window, operating a door, or any other function that might otherwise be found on a control panel within a vehicle. In addition to or instead of control elements, informational elements showing time, volume level, entertainment choices, a GPS position, or the like can also be included in the display. In some implementations, these informational elements can be repositioned, resized, or eliminated by touch input on the display as further described herein.

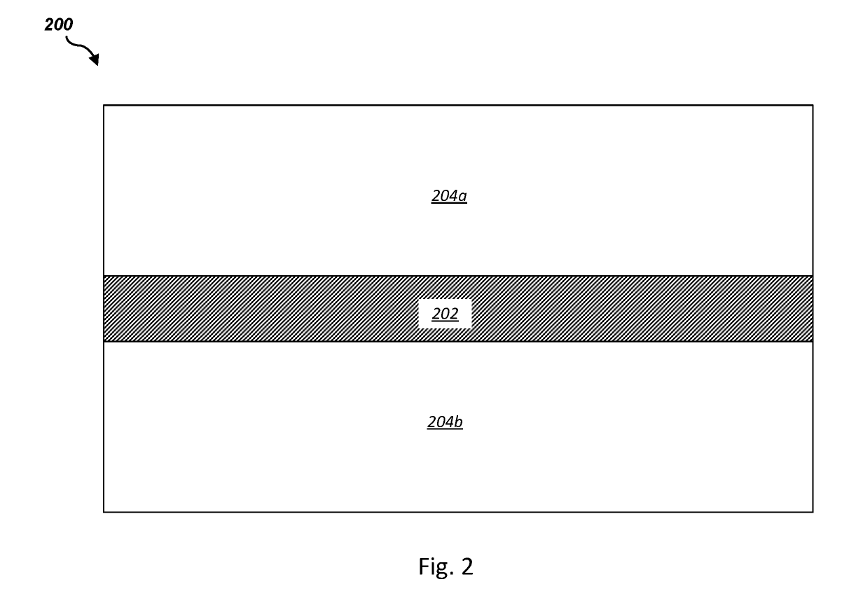

FIG. 2 is a cross-section of a two-pane window 200 in which an electro-reactive dye substrate 202 can sit between two layers of shatter-resistant glass 204a and 204b. A variety of manufacturing processes can be used for these layers. In some implementations, the electro-reactive dye can be applied to one of the layers of glass before another layer of glass is added. Variations in temperature and pressure, as well as material adhesives, can be used to insure the three layers 204a, 202 and 204b are properly attached to form the window.

The electro-reactive dye substrate 202 can in some implementations be a liquid crystal layer that varies in transparency as current is run through it. For example, the layer can include an electrochromic material and an electrolyte. The substrate 202 can include any conventional liquid crystal film, switchable transparent film, polymer dispersed liquid crystal film, or other layer or layers having electrochromic properties as understood in the art.

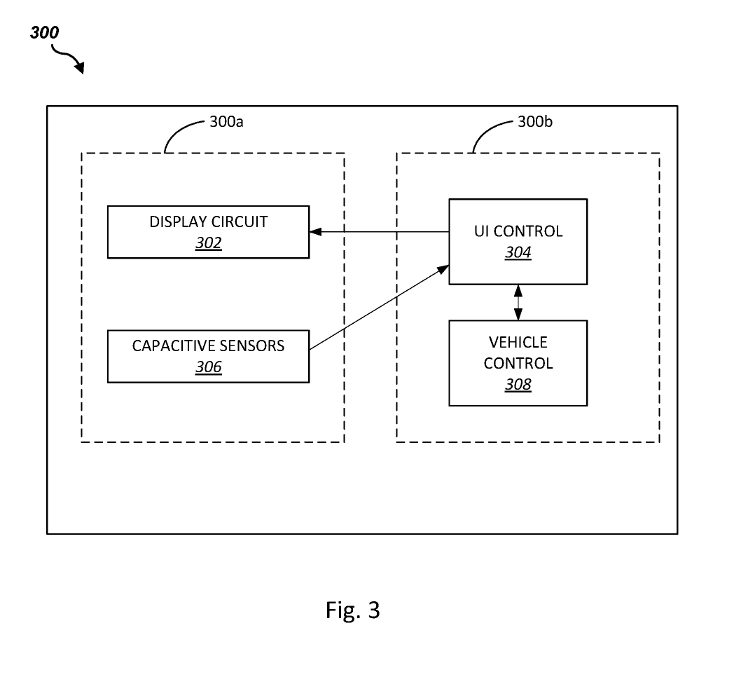

As shown in FIG. 3, a vehicle electrical system 300 can include components that are deployed within a vehicle door, denoted by broken line 300a, and control components deployed as part of a vehicle control unit, denoted by box 300b. Elements of a display circuit 302, which selectively provide current to regions of the electro-reactive dye within the window, can be proximate to the window within the vehicle door (or other vehicle surfaces as appropriate, such as within a ceiling or nearby bulkhead in the case of sunroof or moonroof displays).

A controller 304 can be configured within the vehicle in a number of ways. For example, the controller 304 can be independent or include components independent from a system controller 308 within the vehicle. In some implementations, components of the controller 304 can be disposed within or near the display surface of the window. Alternatively, the controller 304 can be a module within a larger control framework for the vehicle as known in the art.

The system 300 can further include capacitive touch sensors 306 which can be configured in a variety of ways to identify user interaction with the window display. Components of the capacitive touch sensors 306 can be disposed within or attached to components of the window glass. Some components can be placed internally in the vehicle door and can interface with other electrical components.

In some implementations, the capacitive touch sensors 306 can also act as position sensors for windows capable of being lowered, either partially or entirely, within the door or otherwise retracted into another component of the vehicle. In some implementations, standard controllers and sensors for controlling the window position can be used separate from or in addition to the touch sensors 306 and controller 304.

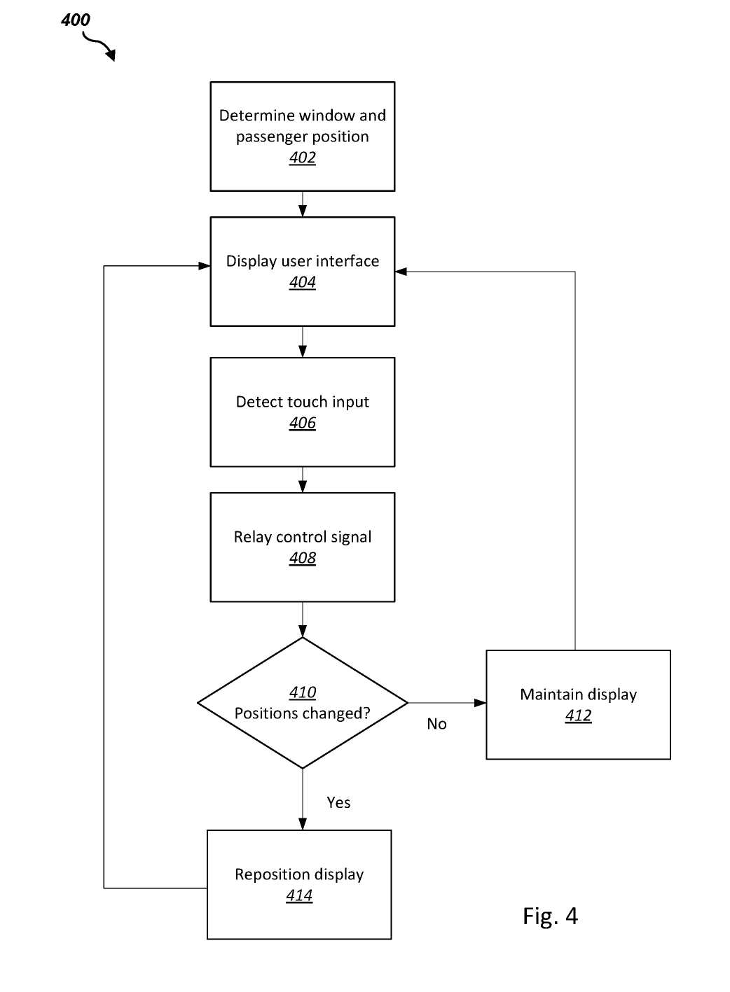

FIG. 4 is a method 400 for interfacing with a user according to embodiments of the present disclosure. In some implementations, the user interface can be displayed in accordance with an initial position of the window and passenger (block 402). This can include determining the presence of a passenger in the seat closest to the display. For example, a passenger window can only display a user interface when the system detects that a passenger is close enough to see and touch the display.

The position of the window, such as a partial or complete retraction of the window, can be taken into account as well as the position of the seat. For example, if the seat is moved forward, the display position can be further forward on the window. If the window is partially retracted, the display position can be further upward on the window. In some implementations, user preferences for which controls to include and where to position them can also be included. The user preferences can, for example, be included as relative positioning while the position of the window and/or passenger can still be further taken into account.

Once any relevant information regarding the user and/or the window is taken into account, the user interface can be displayed (block 404). As described above, this involved the use of circuit components to selectively change the transparency of regions of the window to change the transparency of those regions. A variety of factors can be taken into account in determining the degree of transparency to use in the display—for example, where the window is controllable and the user has chosen to reduce the transparency of the overall window for privacy or comfort, the transparency of the display regions can be greater than the transparency of the rest of the window. The degree of contrast can also be user-determinable and can depend on the interior and/or exterior lighting conditions prevailing in the vehicle. For example, at night, greater contrast can be required for visibility than during the day.

Capacitive touch sensors can relay interaction between the user and the interface (block 406). The size, position, and duration of touch can be communicated, and user input can be characterized by motion as known in the art. A controller, which as described can be specific to the window display interface or integrated with control of other components of the vehicle, can receive and translate the touch input into control signals which are then relayed to the vehicle control system if necessary (block 408).

In some implementations, upon relaying a control signal, the system can determine if the control signal is of the type that can require a repositioning of the display (block 410), such as a command that moves the window or the seat—or, in some implementations, a command that explicitly moves or alters the display. If not, the display can be maintained as before (block 412), although any status information can be updated as necessary. If a position change is indicated, then the display can be repositioned in accordance with the new optimum configuration and/or user preference (block 414).

The data structures and code, in which the present disclosure can be implemented, can typically be stored on a non-transitory computer-readable storage medium. The storage can be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described can be included in hardware components. For example, the hardware components can include, but are not limited to, application-specific integrated circuit (ASIC) chips, field-programmable gate arrays (FPGAs), and other programmable-logic devices now known or later developed. When the hardware components are activated, the hardware components perform the methods and processes included within the hardware components.

The technology described herein can be implemented as logical operations and/or components. The logical operations can be implemented as a sequence of processor-implemented executed blocks and as interconnected machine or circuit components. Likewise, the descriptions of various component components can be provided in terms of operations executed or effected by the components. The resulting implementation is a matter of choice, dependent on the performance requirements of the underlying system implementing the described technology. Accordingly, the logical operations making up the embodiment of the technology described herein are referred to variously as operations, blocks, objects, or components. It should be understood that logical operations can be performed in any order, unless explicitly claimed otherwise or a specific order is inherently necessitated by the claim language.

Various embodiments of the present disclosure can be programmed using an object-oriented programming language, such as SmallTalk, Java, C++, Ada or C#. Other object-oriented programming languages can also be used. Alternatively, functional, scripting, and/or logical programming languages can be used. Various aspects of this disclosure can be implemented in a non-programmed environment, for example, documents created in HTML, XML, or other format that, when viewed in a window of a browser program, render aspects of a GUI or perform other functions. Various aspects of the disclosure can be implemented as programmed or non-programmed elements, or any combination thereof.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

1. A user display within a vehicle comprising:
a window including an electro-reactive dye between two layers of transparent material, the window moving relative to a surrounding surface of the vehicle;
a plurality of circuit components, each component configured to selectively apply an electric current to a different one of a plurality of regions of the electro-reactive dye to adjust the transparency of the one region; and
a controller in communication with the plurality of circuit components, the controller:
creating a display image in a first area of the window by controlling each of the plurality of circuit components and selectively applying electric cutrent to a first selected plurality of the regions of the electro-reactive dye; and
in response to determining that the window has moved relative to the surrounding surface of the vehicle, creating a display image in a second area of the window by controlling each of the plurality of circuit components and selectively applying electric current to a second selected plurality of the regions of the electro-reactive dye.

2. The vehicle user display of claim 1, the controller further, in response to determining that a position of a passenger has moved relative to the window, controlling the circuit components to create a display image in a third area of the window.

3. The vehicle user display of claim 1 further comprising:
a plurality of capacitive touch sensors relaying a plurality of distinguishable user inputs from contact with the window.

4. The vehicle user display of claim 3, the controller further relaying one of a plurality of different control demands to a vehicle control system based on identifying the relayed user input and the created display image.

5. The vehicle user display of claim 4, wherein the relayed command is one of an entertainment system control command, a climate system control command, a navigation system control command, an automobile interior control command, a communication device control command, or an automobile information status request.

6. The vehicle user display of claim 3, the controller further:
receiving information from the vehicle control system in response to the relayed command, and:
based on the received information, altering the display image.

7. The vehicle user display of claim 6, wherein the relayed command results in moving the window, and wherein the display image is repositioned to compensate for the moved window.

8. The vehicle user display of claim 6, wherein the relayed command results in moving a user's seat within the vehicle, and wherein the display image is repositioned to compensate for the moved seat.

9. The vehicle user display of claim 1, wherein the transparency of the displayed image is selected to contrast with a user-selected transparency of the window.

10. The vehicle user display of claim 1, wherein the window comprises one of a liquid crystal film, switchable transparent film, or polymer dispersed liquid crystal film.

11. The vehicle user display of claim 1, wherein the transparent material is shatter-resistant glass meeting industry standards for use in a consumer passenger vehicle.

12. A computer-implemented method, comprising:
selectively applying current to fewer than all of a plurality of circuit components contacting regions of electro-reactive dye within a vehicle window in order to create an image in a first area of the window with a contrast in transparency between the selected regions and adjacent regions of the dye;
in response to determining that the window has moved relative to a surrounding surface of the vehicle, selectively applying the current to a different plurality of the circuit components to create the image in a second area of the window.

13. The computer-implemented method of claim 12, further comprising:
in response to determining that a position of a passenger has moved relative to the window, selectively applying the current to a further different plurality of the circuit components to create the image in a third area of the window.

14. The computer-implemented method of claim 12, further comprising:
receiving, from at least one of a plurality of capacitive touch sensors, data representing at least one of a plurality of distinguishable user inputs from contact with the window.

15. The computer-implemented method of claim 14, further comprising:
relaying one of a plurality of different control demands to a vehicle control system based on identifying the relayed user input and the created display image.

16. The computer-implemented method of claim 15, wherein the relayed command is one of an entertainment system control command, a climate system control command, a navigation system control command, an automobile interior control command, a communication device control command, or an automobile information status request.

17. The computer-implemented method of claim 15, further comprising:
receiving information from the vehicle control system in response to the relayed command, and:
based on the received information, altering the display image.

18. The computer-implemented method of claim 17, wherein the relayed command results in moving the window, and wherein the display image is repositioned to compensate for the moved window.

19. The computer-implemented method of claim 17, wherein the relayed command results in moving a user's seat within the vehicle, and wherein the display image is repositioned to compensate for the moved seat.

20. The computer-implemented method of claim 12, wherein the transparency of the displayed image is selected to contrast with a user-selected transparency of the window.
